(19) United States
(12) Patent Application Publication
(10) Pub. No.: US 2024/0174082 A1
(43) Pub. Date: May 30, 2024

(54) VEHICLE AND METHOD FOR ADJUSTING USER DEVICES FOR USER OF VEHICLE

(71) Applicants: Hyundai Motor Company, Seoul (KR); Kia Corporation, Seoul (KR)

(72) Inventor: Taeho Lee, Seoul (KR)

(21) Appl. No.: 18/237,007

(22) Filed: Aug. 23, 2023

(30) Foreign Application Priority Data
Nov. 29, 2022 (KR) 10-2022-0163209

(51) Int. Cl. B60K 35/00; B60R 16/037; B60W 40/08

(52) U.S. Cl. CPC B60K 35/00; B60R 16/037; B60W 40/08; B60K 2370/741; B60W 2540/22; B60W 2540/221

(57) ABSTRACT

A vehicle may include an analyzer configured to analyze a state of a user based on bio-information of the user; a controller configured to control at least one user device based on preference information of the user and the analyzed state, such that the user is provided with a service; wherein the preference information may be transmitted from a metaverse server to the vehicle through a vehicle management server, and may include information about different methods of coping with different states of the user.

### CROSS-REFERENCE TO RELATED APPLICATIONS

This application claims the benefit of Korean Patent Application No. 10-2022-0163209, filed on Nov. 29, 2022, which application is hereby incorporated herein by reference.

### TECHNICAL FIELD

The disclosure relates to a vehicle and a method for providing emotion care service for a user of the vehicle.

### BACKGROUND

The metaverse is evolving as a new world or platform where virtual and reality converge, allowing people and objects to interact, and creating value in various fields such as society, culture, art, shopping, education, and gaming.

User may access the metaverse server through their terminals, create their own characters, and engage in various activities in the virtual space.

The metaverse server provides services to record, store, transmit, and share everyday experiences and information about objects and people.

Connected car services may link a vehicle of a user and a terminal of the user to offer various services such as accident and emergency situation response, vehicle management, and road guidance.

User may utilize connected car services by performing vehicle and account linkage through their user terminals. The connected car server that provides the connected car services may store user information, vehicle information, and device settings within the vehicle for each user account.

### SUMMARY

Connected car services may include real-time audio services such as music streaming and podcasts that are provided through the built-in communication terminal in the vehicle. Additionally or alternatively, connected car services may include services that bring comfort to vehicle users and help relieve emotions, such as adjusting seats and mood lighting, for example.

Emotion care services may be provided uniformly, overlooking the fact that different users have different ways of relieving emotions based on their emotional states.

According to the present disclosure, a vehicle may comprise: an analyzer configured to: receive, from a metaverse server, preference information associated with at least one user of a plurality of users, wherein the preference information indicates different methods of coping with different states of the at least one user; and based on bio-information, collected by at least a sensor of the analyzer, associated with the at least one user, analyze a state of the at least one user; and a controller configured to, based on the analyzed state of the at least one user and the preference information, control at least one of a plurality of user devices for providing a service, implementing one of the different methods, to the at least one user.

The analyzer may comprise: the at least the sensor configured to detect bio-information including at least one of: a facial expression; a respiration rate; a blood pressure; a voice; a body temperature; or a pulse of the user; and a converter configured to: based on the detected bio-information, determine the state of the at least one user; and convert the determined state of the at least one user to a numerical value. The plurality of user devices may comprise at least one of: a mood lamp; a fragrance dispenser; an air conditioning device; an audio device, a video device; a seat massager; or an electric curtain; and wherein the controller is further configured to: based on the preference information associated with the at least one user, classify a preference of the at least one user as one of preset types; and based on the one of the preset types and the numerical value converted by the converter, control the at least one of the plurality of user devices.

The controller may be further configured to: determine that the numerical value reaches a target value by controlling the at least one of the plurality of user devices; and based on the determination that the numerical value reaches the target value, switch a mode of controlling the at least one of the plurality of user devices from an individualized service mode to a batch service mode, wherein: the at least one of the plurality of user devices, in the individualized service mode, is controlled based on a current state of each of the plurality of users; and the at least one of the plurality of user devices, in the batch service mode, is controlled uniformly for the plurality of users.

According to the present disclosure, a method for a vehicle, the method may comprise: based on activities performed by at least one user, of a plurality of users, through a character played in a metaverse, receiving preference information associated with the at least one user; collecting, by a sensor of the vehicle, bio-information associated with the at least one user; analyzing, based on the collected bio-information, a state of the at least one user; and controlling, by the vehicle and based on the preference information and the analyzed state of the at least one user, at least one of a plurality of user devices for providing a service to the at least one user. The receiving the preference information may comprise: causing a metaverse server to generate the character played by the at least one user who is connected thereto through a user terminal, and causing the metaverse server to, based on a history of activities performed by the at least one user through the character, analyze a preference of the at least one user. The receiving the preference information may further comprise: classifying different methods of coping with different states of the at least one user. The receiving the preference information further comprises: receiving the preference information stored in a database, associated with account information of the at least one user, of a vehicle management server. The receiving the preference information comprises: checking a communication connection status between a vehicle management server and a vehicle associated with account information of the at least one user.

The collecting the bio-information may comprise: detecting bio-information including at least one of: a facial expression of the at least one user; a respiration rate of the at least one user; a blood pressure of the at least one user; a voice of the at least one user; a body temperature of the at least one user; and a pulse of the at least one user; and wherein the analyzing comprises: determining, based on the detected bio-information, the state of the at least one user; and converting the determined state of the at least one user to a numerical value. The controlling may comprise: classifying, based on the preference information a preference of the at least one user as one of preset types; and controlling, based on the one of the preset types and the numerical value, the at least one of the plurality of user devices. The controlling may further comprise: determining that the numerical value reaches a target value by controlling the at least one of the plurality of user devices; and based on the determining, switching a mode of controlling the at least one of the plurality of user devices from an individualized service mode to a batch service mode, wherein: the at least one of the plurality of user devices, in the individualized service mode, is controlled based on a current state of each of the plurality of users; and the at least one of the plurality of user devices, in the batch service mode, is controlled uniformly for the plurality of users.

### BRIEF DESCRIPTION OF THE DRAWINGS

These and/or other examples of the disclosure will become apparent and more readily appreciated from the following description of the examples, taken in conjunction with the accompanying drawings of which:

FIG. 1 shows examples of components of a vehicle example.

FIG. 2 shows an example of a flowchart showing steps of a method of providing an emotion care service for a user of a vehicle.

### DETAILED DESCRIPTION

Like reference numerals throughout the specification denote like elements. Also, this specification does not describe all the elements according to examples of the disclosure, and descriptions well-known in the art to which the disclosure pertains or overlapped portions are omitted.

It will be understood that if an element is referred to as being “connected” to another element, it may be directly or indirectly connected to the other element, wherein the indirect connection includes “connection” via a wireless communication network.

It will be understood that the term “include” if used in this specification specifies the presence of stated features, integers, steps, operations, elements, and/or components, but does not preclude the presence or addition of at least one other feature, integer, step, operation, element, component, and/or group thereof.

It is to be understood that the singular forms are intended to include the plural forms as well, unless the context clearly dictates otherwise.

The terms such as “˜part,” “˜device,” “˜block,” “˜member”, “˜module,” and the like may refer to a unit for processing at least one function or act. For example, the terms may refer to at least process processed by at least one hardware, such as a field-programmable gate array (FPGA)/application specific integrated circuit (ASIC), software stored in memories or processors.

Reference numerals used for method steps are just used for convenience of explanation, but not to limit an order of the steps. Thus, unless the context clearly dictates otherwise, the written order may be practiced otherwise.

Hereinafter, examples of the disclosure will be described in detail with reference to the accompanying drawings.

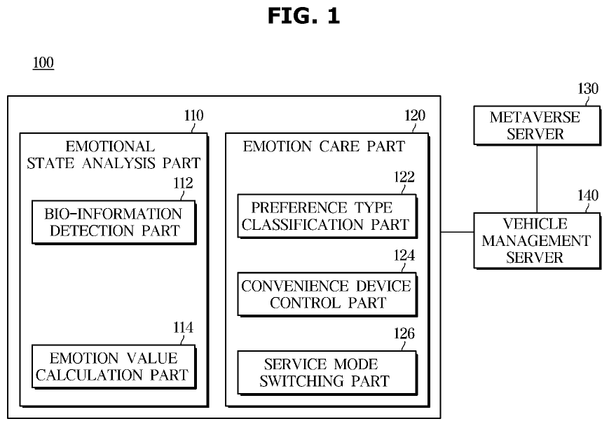

FIG. 1 shows examples of components of a vehicle.

Referring to FIG. 1, a vehicle 100 according to an example includes an emotional state analysis part 110 configured to analyze an emotional state of a user based on bio-information of the user, and an emotion care part 120 configured to control at least one user convenience device based on preference information of the user and the emotional state analyzed by the emotional state analysis part 110, such that the user is provided with an emotion care service.

The emotional state analysis part 110 may detect the current bio-information of a user who may be riding in a vehicle 100 and may analyze an emotional state of the user based on the detected bio-information of the user. In the case where multiple people are riding in the vehicle 100, bio-information detection and emotional state analysis may be performed for each user.

In addition, after analyzing the emotional state of the user, the emotional state analysis part 110 may re-evaluate the emotional state of the user who is riding in the vehicle 100 if external shocks, collisions, or other external environmental factors occur. Furthermore, it is possible to continuously monitor the emotional state of the user who is riding in the vehicle 100 at regular intervals.

The emotional state analysis part 110 may include a bio-information detection part 112 configured to detect bio-information including at least one of a facial expression, a respiration rate, a blood pressure, a voice, a body temperature, and/or a pulse of the user, and an emotion value calculation part 114 configured to determine the emotional state of the user based on the bio-information detected by the bio-information detection part 112 and calculate the determined emotional state of the user as a numerical value.

The bio-information detection part 112 may include at least one of camera and bio-information detection sensor. The bio-information detection sensor may measure electrocardiogram, skin resistance, skin temperature, brain waves, heart rate, blood pressure, and/or more. For example, if the user is currently in an angry state, the user's heart rate may increase more than usual and blood vessels contract, resulting in higher blood pressure.

The emotion value calculation part 114 may calculate the user's emotional state into a numerical value based on the bio-information detected by the bio-information detection part 112. For example, if the user's respiration rate, blood pressure, heart rate, voice, and facial expressions measured by the bio-information detection part 112 exceed the set values for anger, the emotion value calculation part 114 may calculate the user's anger level as a numerical value (i.e., an emotional index) based on 100 as a reference point. Specifically, based on the bio-information detected by the bio-information detection part 112, the emotion value calculation part 114 may calculate an anger index of 70 based on 100 as a reference point, depending on the degree of anger.

The emotion care part 120 may control user convenience device based on the user's current emotional state analyzed by the emotional state analysis part 110 and the user's preference information received from a vehicle management server 140. The user convenience device may comprise at least one of a mood lamp, a fragrance dispenser, an air conditioning device, an audio device, a video device, a seat massager, and/or an electric curtain.

The emotion care part 120 may include a preference type classification part 122 configured to classify a preference of the user based on the preference information of the user according to preset types, a convenience device control part 124 configured to control the user convenience device based on the preference of the user classified according to the preset types and the numerical value calculated by the emotion value calculation part 114, and a service mode switching part 126 configured to switch a service mode from an individual care service for controlling the user convenience device according to a current emotional state of each user to a batch care service for providing the user convenience device uniformly to all users if the numerical value calculated by the emotion value calculation part 114 reaches a target value through the control of the user convenience device.

The preference information may be transmitted from a metaverse server 130 to the emotion care part 120 through the vehicle management server 140, and may include information about a method of relieving an emotion according to the emotional state of the user.

TABLE 1

| USER | A | B | C | D |
|---|---|---|---|---|
| ANGER | VISITING | EXCITING | EXPRESSING | SPEEDY |
| RELIEVING | OPEN | EX- | OR SHARING | MOVE- |
| METHOD | AREAS | PERIENCE | CAUSE OF | MENT |
| | LIKE SEA | | ANGER WITH | |
| | | | OTHERS | |
| BOREDOM | WATCHING | WATCHING | NEW | ACQUIRING |
| | COMEDY | VARIETY | CHALLENGES | NEW |
| RELIEVING | MOVIES | SHOWS ON | WITH OTHERS | KNOW- |
| METHOD | | TV | | LEDGE |

Referring to Table 1, for instance, the metaverse server 130 may analyze the activity history of each users A to D to identify their anger and boredom relief methods, which may be generated as personality information for each users A to D.

Users may engage in various activities in social, cultural, artistic, shopping, educational, gaming, and other fields through their characters in the metaverse. The user's character activity history may include various information such as the characteristics of the character, the fields in which the user participated through the character, activity time, activity method, activity content, conversation content, and/or input content.

The metaverse server 130 may analyze the user's character activity history to identify methods in which the user may relieve emotions such as anger. Thus, the metaverse server 130 may generate user preference information based on the methods in which the user relieves emotions according to the user's emotional state.

In Table 1, for example, user B is relieving anger emotion through exciting experiences, and this method of relieving anger emotion may be generated as user B's preference information. Similarly, user D is relieving anger emotion through speedy movement, and this method of relieving anger emotion may be generated as user D's preference information.

Table 1 may represent the preference of each user for relieving negative emotions, but the methods for increasing positive emotions, such as creating joy or happiness, may also be generated as each user's preference information.

The metaverse server 130 may be connected to the vehicle management server 140, which may store each user's account information (ID, password, etc.), and may transmit each user's preference information to the vehicle management server 140.

The vehicle management server 140 may store the preference information of each user received from the metaverse server 130 in a database of the vehicle management server 140 to correspond to account information of each user.

The vehicle management server 140 may store the preference information of each user with a registered account, registered vehicles, and/or device setting information of the registered vehicles.

The vehicle management server 140 may include devices for providing Connected Car services.

If each users A to D gets on the vehicle 100 and starts the engine, the vehicle management server 140 may communicate with the vehicle 100 to send each user's preference information. For example, the vehicle management server 140 may link the preference information received from the metaverse server 130 to each user's account information and may store it, and if the engine of the vehicle 100 is started, the vehicle management server 140 may communicate with the vehicle 100 to send each user's preference information to the vehicle 100.

The preference type classification part 122 may classify the user's preference based on the received preference information from the vehicle management server 140 according to preset types.

For example, based on the method of relieving emotions for each user's emotional state described in Table 1, the preference type classification part 122 may classify user A as an internal general type, user B as an internal expression type, user C as an external expression type, and user D as an internal challenging type.

The convenience device control part 124 may control the user convenience device based on the preference of the user classified by the preference type classification part 122 according to the preset types and the numerical value calculated by the emotion value calculation part 114.

TABLE 2

| | A | B | C | D |
|---|---|---|---|---|
| | INTERNAL | INTERNAL | EXTERNAL | INTERNAL |
| | GENERAL | EX- | EX- | CHALLENGING |
| | TYPE | PRESSION | PRESSION | TYPE |
| | (OPEN- | TYPE | TYPE | (HIGH-SPEED, |
| | ING | (EXCITING | (WITH | NEW |
| CATEGORY | UP) | EXPERIENCE) | OTHERS) | KNOWLEDGE) |
| MOOD | LIGHT | GREEN | BLUE | SILVER |
| LAMP | GREEN | | | |
| FRAGRANCE | AQUA | CITRUS | FLORAL | SPICY |
| DISPENSER | SCENT | SCENT | SCENT | |
| AIR | 18° C. | 20° C. | GENTLE | 18° C., |
| CONDITIONING | | | BREEZE | STRONG |
| DEVICE | | | | WIND |
| AUDIO | SOUND OF | ROCK | UPBEAT | FAST-PACED |
| DEVICE | WAVES | MUSIC | MUSIC | MUSIC |
| VIDEO | OCEAN | GAME | TRAVEL | HIGH-SPEED |
| DEVICE | VIDEO | VIDEO | VIDEO | DRIVING |
| | | | | VIDEO |
| SEAT | RELAX | RELAX | FULL-BODY | TIGHT SEAT |
| MASSAGER | POSTURE | POSTURE | MASSAGE | |

Suppose that user A of vehicle 100 has anger feelings, and the anger index calculated by the emotion value calculation part 114 represents 70.

For example, referring to Table 2, the convenience device control part 124 may control user convenience device for user A. For instance, the convenience device control part 124 may emit the light green light by the mood lamp, release the aqua scent by the fragrance dispenser, adjust the temperature to 18° C. by the air conditioning. Additionally or alternatively, the convenience device control part 124 may produce the sound of waves by the audio device, display the ocean video by the video device, and control the seat massager to provide user A with the relax posture.

Moreover, the convenience device control part 124 may control user convenience device for a certain period of time until the user A's anger index (e.g., 70) calculated by the emotion value calculation part 114 reaches the target value (e.g., 10).

Likewise, for the remaining users B to D riding in the vehicle 100, the convenience device control part 124 may provide the user convenience device, and control over the user convenience device may be exercised until each user's emotional index reaches the target value.

The service mode switching part 126 may switch a service mode from an individual care service for controlling the user convenience device according to a current emotional state of each user to a batch care service for providing the user convenience device uniformly to all users if the numerical value calculated by the emotion value calculation part 114 reaches a target value through the control of the user convenience device by the convenience device control part 124.

For this purpose, the service mode switching part 126 may set each user convenience device to the settings before providing the individual care service. In another example, the service mode switching part 126 may set each user convenience device to the initial settings. The initial settings may be the values set if each user convenience device is installed in the vehicle 100.

By utilizing the user's activity history in the metaverse, the user's preference may be analyzed and used to provide personalized services that integrate the metaverse server 130, the vehicle management server 140, and the vehicle 100 for emotion care during vehicle usage.

The vehicle 100 may include a controller (not shown) controlling the constituent components of the vehicle 100 and means related thereto. The controller may include various types of processors and memories. The memory may store programs, instructions, applications, etc., for control. Each processor may execute the programs, the instructions, the applications, etc., stored in the memory. For example, the controller may include control units such as an electronic control unit (ECU), micro controller unit (MCU), and the like.

The memory may include, for example, a volatile memory such as a random access memory (RAM), a non-volatile memory such as a cache, a flash memory, a read only memory (ROM), a programmable read only memory (PROM), an erasable programmable read only memory (EPROM), an electrically erasable programmable read only memory (EEPROM), etc., or a recording media such as a hard disk drive (HDD), or a compact disc read only memory (CD-ROM), without being limited thereto. The memory may store information such as the user's preference information received from the aforementioned vehicle management server 140, setting information of the convenience devices, the user's biological information detected by the bio-information detection part 112, the categorized preference type of the user classified by the preference type classification part 122, and numerical values calculated by the emotion value calculation part 114.

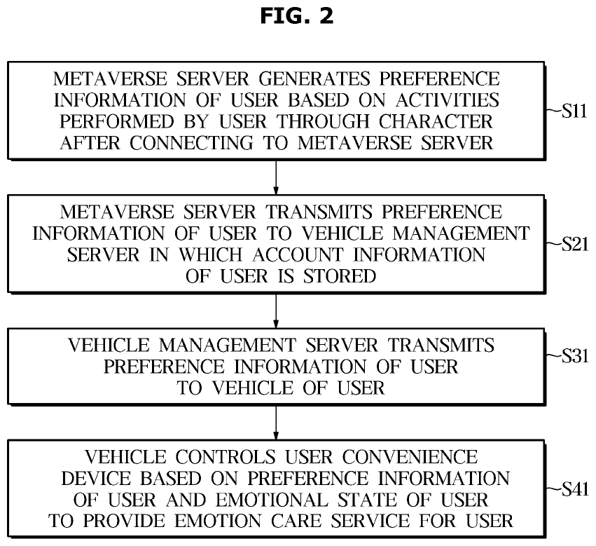

FIG. 2 shows an example of a flowchart showing steps of a method of providing an emotion care service for a user of a vehicle.

First, the metaverse server 130 may generate preference information of a user based on activities performed by the user through a character after connecting to the metaverse server 130 (S11).

In operation S11, the metaverse server 130 may include generating a character of the user who is connected thereto through a user terminal, and analyzing a preference of the user based on a history of activities performed by the user through the character. The metaverse server 130 may generate preference information of the user based on the analyzed preference of the user.

Herein, the generating of the preference information of the user may include classifying emotional relief methods according to the emotional state of the user.

The user terminal may be either a portable device or a fixed device. A portable device may be an electronic device that is easy to carry and movable, and may include video calling devices, mobile phones, smartphones, WCDMA (Wideband Code Division Multiple Access) devices, UMTS (Universal Mobile Telecommunication Service) devices, PDAs (Personal Digital Assistants), PMPs (Portable Multimedia Players), DMB (Digital Multimedia Broadcasting) devices, E-Books, portable computers (notebooks, tablets, etc.), or digital cameras. A fixed device may be an electronic device that may be fixed in a specific location and used, and may include desktop personal computers, smart TVs, and the like.

Each user may request to create a character for activities in the metaverse by accessing the metaverse server 130 through their own portable device, such as a mobile phone. The metaverse server 130 may analyze the activity history of each user's character and generate user preference information.

The activity history of each user's character may include the contents of the user's own emotion relief method that they checked by accessing the metaverse server 130 directly. Therefore, the metaverse server 130 may also generate user preference information based on the emotion relief method directly written by the user.

Next, the metaverse server 130 may transmit the preference information of the user to a vehicle management server 140 in which account information of the user is stored (S21).

The metaverse server 130 may link with the vehicle management server 140 where information regarding the user's vehicle is registered through the user's account information and transmit the user preference information to the vehicle management server 140.

In operation S21, the preference information of the user received from the metaverse server 130 may be stored in a database of the vehicle management server 140 to correspond to account information of the user.

Next, the vehicle management server 140 may transmit the preference information of the user to the vehicle 100 of the user (S31).

In operation S31, the transmitting of the preference information of the user to the vehicle may include checking a communication connection status between the vehicle management server 140 and the vehicle 100 associated with the account information, and transmitting the preference information of the user to the vehicle 100.

If the user gets in the vehicle 100 and turns on the ignition, the vehicle management server 140 may communicate with the vehicle 100 and transmit the user preference information to the vehicle 100.

Next, the vehicle 100 may control the user convenience device based on the preference information of the user and an emotional state of the user to provide an emotion care service for the user (S41).

In operation S41, the providing of the emotion care service for the user may include detecting bio-information including at least one of a facial expression, a respiration rate, a blood pressure, a voice, a body temperature, and/or a pulse of the user, and determining the emotional state of the user based on the detected bio-information and calculating the determined emotional state of the user as a numerical value.

In addition, the providing of the emotion care service for the user may include classifying a preference of the user based on the preference information of the user according to a preset type, and controlling the user convenience device based on the preference of the user classified according to the preset type and the calculate numerical value.

In addition, the providing of the emotion care service for the user may include switching a service mode from an individual care service for controlling the user convenience device according to a current emotional state of each user to a batch care service for providing the user convenience device uniformly to all users if the numerical value reaches a target value through the controlling of the user convenience device.

An example of the disclosure is to provide a vehicle and a method for providing emotion care service for a user of the vehicle by recognizing preference of the user based on a history of activities performed in the metaverse, and effectively utilizing it for emotion care of the user who ride in the vehicle.

According to an example of the disclosure, there is provided a vehicle including: an emotional state analysis part configured to analyze an emotional state of a user based on bio-information of the user; an emotion care part configured to control at least one user convenience device based on preference information of the user and the emotional state analyzed by the emotional state analysis part, such that the user is provided with an emotion care service; wherein the preference information is transmitted from a metaverse server to the emotion care part through a vehicle management server, and includes information about a method of relieving an emotion according to the emotional state of the user.

The emotional state analysis part may comprise a bio-information detection part configured to detect bio-information including at least one of a facial expression, a respiration rate, a blood pressure, a voice, a body temperature, and a pulse of the user; and an emotion value calculation part configured to determine the emotional state of the user based on the bio-information detected by the bio-information detection part and calculate the determined emotional state of the user as a numerical value.

The user convenience device may comprise at least one of a mood lamp, a fragrance dispenser, an air conditioning device, an audio device, a video device, a seat massager, and an electric curtain; and wherein the emotion care part may comprise a preference type classification part configured to classify a preference of the user based on the preference information of the user according to preset types; and a convenience device control part configured to control the user convenience device based on the preference of the user classified according to the preset types and the numerical value calculated by the emotion value calculation part.

The emotion care part may further comprise a service mode switching part configured to switch a service mode from an individual care service for controlling the user convenience device according to a current emotional state of each user to a batch care service for providing the user convenience device uniformly to all users if the numerical value calculated by the emotion value calculation part reaches a target value through the control of the user convenience device.

According to another example of the disclosure, there is provided a method of providing emotion care service for a user of a vehicle comprising: generating, by a metaverse server, preference information of a user based on activities performed by the user through a character after connecting to the metaverse server; transmitting, by the metaverse server, the preference information of the user to a vehicle management server in which account information of the user is stored; transmitting, by the vehicle management server, the preference information of the user to a vehicle of the user; and controlling, by the vehicle, a user convenience device based on the preference information of the user and an emotional state of the user to provide an emotion care service for the user.

The generating of the preference information of the user may comprise generating, by the metaverse server, a character of the user who is connected thereto through a user terminal, and analyzing a preference of the user based on a history of activities performed by the user through the character.

The generating of the preference information of the user may further comprise classifying emotional relief methods according to the emotional state of the user.

The method may further comprise storing the preference information of the user received from the metaverse server in a database of the vehicle management server to correspond to account information of the user.

The transmitting of the preference information of the user to the vehicle may comprise checking a communication connection status between the vehicle management server and a vehicle associated with the account information, and transmitting the preference information of the user to the vehicle.

The providing of the emotion care service for the user may comprise detecting bio-information including at least one of a facial expression, a respiration rate, a blood pressure, a voice, a body temperature, and a pulse of the user, and determining the emotional state of the user based on the detected bio-information and calculating the determined emotional state of the user as a numerical value.

The providing of the emotion care service for the user may comprise classifying a preference of the user based on the preference information of the user according to preset types, and controlling the user convenience device based on the preference of the user classified according to the preset types and the calculate numerical value.

The providing of the emotion care service for the user may comprise switching a service mode from an individual care service for controlling the user convenience device according to a current emotional state of each user to a batch care service for providing the user convenience device uniformly to all users if the numerical value reaches a target value through the controlling of the user convenience device.

Examples of the disclosure have thus far been described with reference to the accompanying drawings. It should be apparent to those of ordinary skill in the art that the disclosure may be practiced in other forms than the examples as described above without changing the technical idea or essential features of the disclosure. The above examples are only by way of example, and should not be interpreted in a limited sense.

What is claimed is:

1. A vehicle comprising:
an analyzer configured to:
receive, from a metaverse server, preference information associated with at least one user of a plurality of users, wherein the preference information indicates different methods of coping with different states of the at least one user; and
based on bio-information, collected by at least a sensor of the analyzer, associated with the at least one user, analyze a state of the at least one user; and
a controller configured to, based on the analyzed state of the at least one user and the preference information, control at least one of a plurality of user devices for providing a service, implementing one of the different methods, to the at least one user.

2. The vehicle of claim 1, wherein the analyzer comprises:
the at least the sensor configured to detect bio-information including at least one of:
a facial expression;
a respiration rate;
a blood pressure;
a voice;
a body temperature; or
a pulse of the user; and
a converter configured to:
based on the detected bio-information, determine the state of the at least one user; and
convert the determined state of the at least one user to a numerical value.

3. The vehicle of claim 2, wherein the plurality of user devices comprise at least one of:
a mood lamp;
a fragrance dispenser;
an air conditioning device;
an audio device, a video device;
a seat massager; or
an electric curtain; and
wherein the controller is further configured to:
based on the preference information associated with the at least one user, classify a preference of the at least one user as one of preset types; and
based on the one of the preset types and the numerical value converted by the converter, control the at least one of the plurality of user devices.

4. The vehicle of claim 3, wherein the controller is further configured to:
determine that the numerical value reaches a target value by controlling the at least one of the plurality of user devices; and
based on the determination that the numerical value reaches the target value, switch a mode of controlling the at least one of the plurality of user devices from an individualized service mode to a batch service mode, wherein:
the at least one of the plurality of user devices, in the individualized service mode, is controlled based on a current state of each of the plurality of users; and
the at least one of the plurality of user devices, in the batch service mode, is controlled uniformly for the plurality of users.

5. A method for a vehicle, the method comprising:
based on activities performed by at least one user, of a plurality of users, through a character played in a metaverse, receiving preference information associated with the at least one user;
collecting, by a sensor of the vehicle, bio-information associated with the at least one user;
analyzing, based on the collected bio-information, a state of the at least one user; and
controlling, by the vehicle and based on the preference information and the analyzed state of the at least one user, at least one of a plurality of user devices for providing a service to the at least one user.

6. The method of claim 5, wherein the receiving the preference information comprises:
causing a metaverse server to generate the character played by the at least one user who is connected thereto through a user terminal, and
causing the metaverse server to, based on a history of activities performed by the at least one user through the character, analyze a preference of the at least one user.

7. The method of claim 6, wherein the receiving the preference information further comprises:
classifying different methods of coping with different states of the at least one user.

8. The method of claim 5, wherein the receiving the preference information further comprises:
receiving the preference information stored in a database, associated with account information of the at least one user, of a vehicle management server.

9. The method of claim 5, wherein the receiving the preference information comprises:
checking a communication connection status between a vehicle management server and a vehicle associated with account information of the at least one user.

10. The method of claim 5, wherein the collecting the bio-information comprises:
detecting bio-information including at least one of:
a facial expression of the at least one user;
a respiration rate of the at least one user;
a blood pressure of the at least one user;
a voice of the at least one user;
a body temperature of the at least one user; and
a pulse of the at least one user; and
wherein the analyzing comprises:
determining, based on the detected bio-information, the state of the at least one user; and
converting the determined state of the at least one user to a numerical value.

11. The method of claim 10, wherein the controlling comprises:
classifying, based on the preference information a preference of the at least one user as one of preset types; and
controlling, based on the one of the preset types and the numerical value, the at least one of the plurality of user devices.

12. The method of claim 11, wherein the controlling further comprises:
determining that the numerical value reaches a target value by controlling the at least one of the plurality of user devices; and
based on the determining, switching a mode of controlling the at least one of the plurality of user devices from an individualized service mode to a batch service mode, wherein:
the at least one of the plurality of user devices, in the individualized service mode, is controlled based on a current state of each of the plurality of users; and
the at least one of the plurality of user devices, in the batch service mode, is controlled uniformly for the plurality of users.
